(19) United States
(12) Patent Application Publication
(10) Pub. No.: US 2010/0325125 A1
(43) Pub. Date: Dec. 23, 2010

(54) MEDIA RECOMMENDATIONS

(75) Inventors: Rodrigo M. Bomfim, Renton, WA (US); Andrew J. Morrison, Woodinville, WA (US); Christopher B. Weare, Bellevue, WA (US); Joshuah Vincent, Seattle, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/487,049

(22) Filed: Jun. 18, 2009

(51) Int. Cl. G06F 17/30; G06F 3/01

(52) U.S. Cl. 707/759; 715/716; 707/769; 707/752; 707/753; 707/754

(57) ABSTRACT

Media recommendation techniques are described. In an implementation, a similarity value is calculated for a plurality of media using a plurality of similarity functions. A vote is assigned for each similarity value that is above a threshold that is assigned for a respective similarity function and the plurality of media is ranked based at least in part on the assigned votes. A playlist is then created based at least in part on the ranking. Media seed techniques are also described. In an implementation, a set of dissimilar candidates are calculated for a plurality of media using a similarity function in which the set of dissimilar candidates describes the media that is dissimilar in comparison with other media included in the plurality of media. A seed is selected using the set of the dissimilar candidates to create a playlist that includes at least some of the plurality of media.

### BACKGROUND

Computers may include a vast amount of media. For example, a user may interact with the computer to access websites to purchase and download music, movies, “audio books,” and so on. Through this and other interaction, a user may use the computer to compile thousands of items of media for later playback. For instance, it is not uncommon for users to store thousands and even tens of thousands of songs on the computer.

Because such a vast amount of music may be stored on the computer, however, it may be difficult to locate particular music of interest. Therefore, a user typically interacts with a limited subset of the vast amount of music that is available to the user. Consequently, the user thereby forgoes a majority of the enjoyment that may be available if the user could locate music of interest using conventional media interaction techniques.

### SUMMARY

Media seed techniques are described. In an implementation, a set of dissimilar candidates are calculated for a plurality of media using a similarity function in which the set of dissimilar candidates describes the media that is dissimilar in comparison with other media included in the plurality of media. A seed is selected using the set of the dissimilar candidates to create a playlist that includes at least some of the plurality of media.

Media recommendation techniques are also described. In an implementation, a similarity value is calculated for a plurality of media using a plurality of similarity functions, which may use the seed calculated above. A vote is assigned for each similarity value that is above a threshold that is assigned for a respective similarity function and the plurality of media is ranked based at least in part on the assigned votes. A playlist is then created based at least in part on the ranking.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an example implementation that is operable to employ media techniques described herein.

FIG. 2 is an illustration of a system in an example implementation in which a seed module of FIG. 1 is shown in greater detail.

FIG. 3 is an illustration of a system in an example implementation in which a recommendation module of FIG. 1 is shown in greater detail.

FIG. 4 is an illustration of a system in an example implementation in which a user interface is used to configure which similarity functions are employed by the recommendation module of FIG. 3.

FIG. 5 is a flow diagram depicting a procedure in an example implementation in which pre-processing is performed to form groups that may serve as a basis for making media recommendations.

FIG. 6 is a flow diagram depicting a procedure in an example implementation in which a seed is formed from data cached using the procedure of FIG. 5.

FIG. 7 is a flow diagram depicting a procedure in an example implementation in which a playlist is formed using a framework of FIGS. 3 and 4.

### DETAILED DESCRIPTION

### Overview

There is a vast amount of media functionality available to users of a computer. However, the sheer amount of media that may be stored using a computer may make it difficult if not impossible to locate particular media of interest. Due to the difficulty of using conventional techniques to locate media that is likely to be of interest to the user, for example, a user may have access to thousands of songs but interact with a limited subset of these songs. Consequently, the user's experience in interacting with media may be frustrating and difficult using conventional techniques.

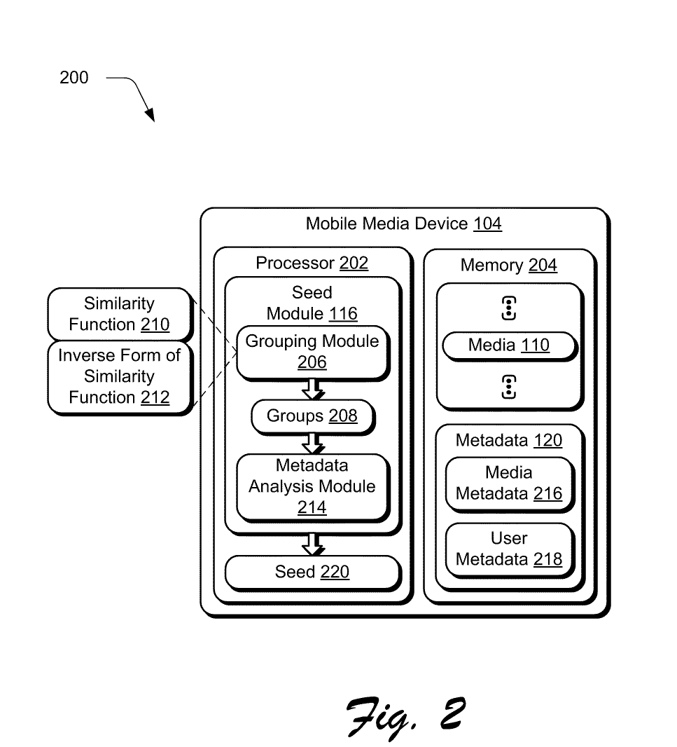

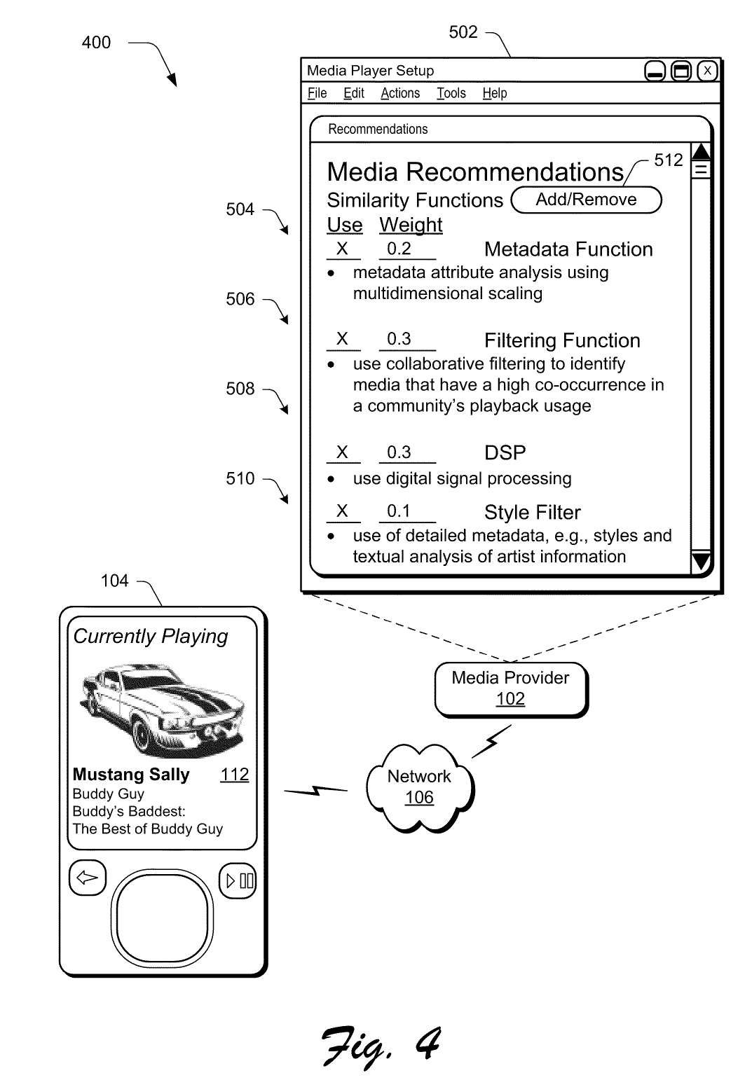

Media seed suggestion and recommendation techniques are described. In an implementation, techniques are described in which a media seed suggestion is generated at least in part based on determining which media are dissimilar to each other. For example, groups of media may be identified using an inverse form of a similarity function to determine which media are dissimilar, one to another. A “seed” may then be selected from the group that is to be used as a basis for generating a playlist. The seed may be selected in a variety of ways, such as based on metadata that describes the media and/or usage of the media, a time of day, and so on. Further discussion of media seed suggestion may be found in relation to FIGS. 2 and 4.

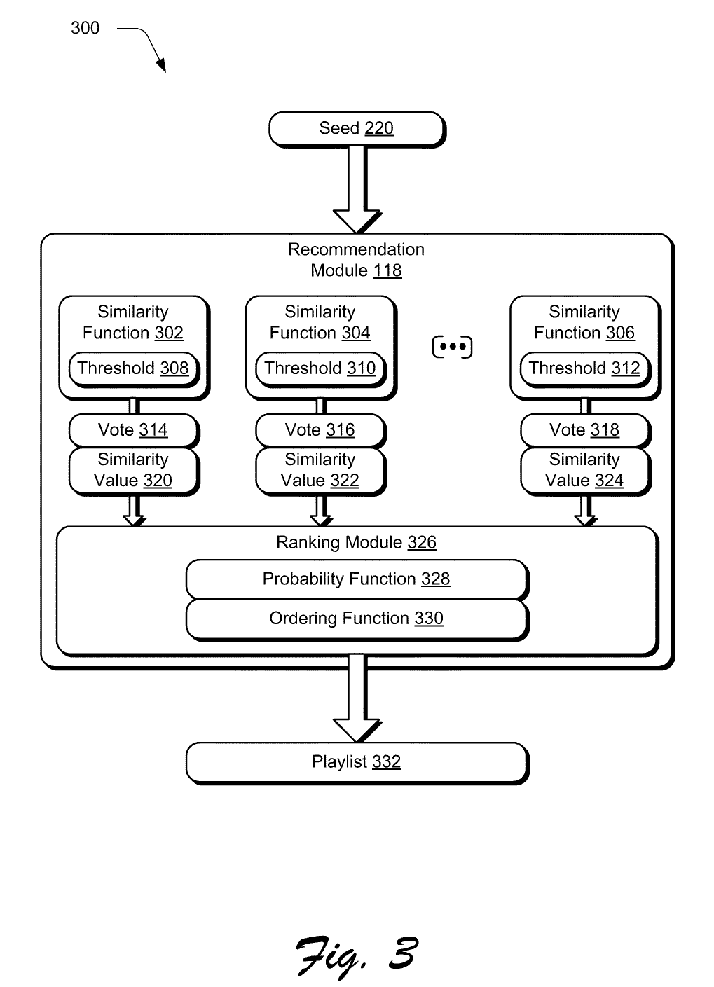

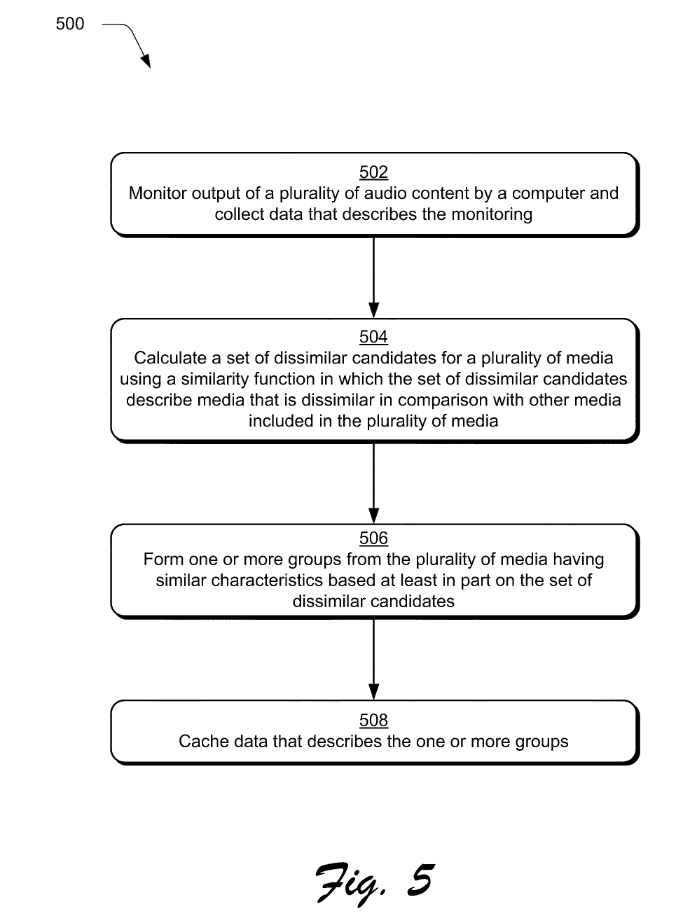

Additionally, techniques are described to form one or more recommendations, such as from the media seed suggestion above. For example, a framework may be implemented that is configured to leverage a variety of different similarity functions to arrive at recommendations of media for output, such as a playlist of media. The framework may be configured in a variety of ways, such as to leverage a voting technique such that the advantages of the different similarity functions may be utilized without having undue influence of one of the similarity functions on the overall result. The framework may also leverage numerical values calculated by the similarity functions for ranking media based on similarity. For instance, the numerical values may be weighted to arrive at a final ranking of the media, one to another. Further discussion of media recommendation techniques may be found in relation to FIGS. 3 and 5.

In the following discussion, a mobile media device is described that may receive audio content wirelessly from a variety of different sources, which may be stored locally on the mobile media device. However, it should be readily apparent that the following discussion is not to be limited to a mobile media device, audio content, or wireless communication and therefore a wide variety of computers are contemplated. Thus, a variety of different devices may employ the techniques described herein without departing from the spirit and scope thereof, such as other computers such as desktop PCs, netbooks, wireless phones, personal digital assistants, and so on.

### Example Environment

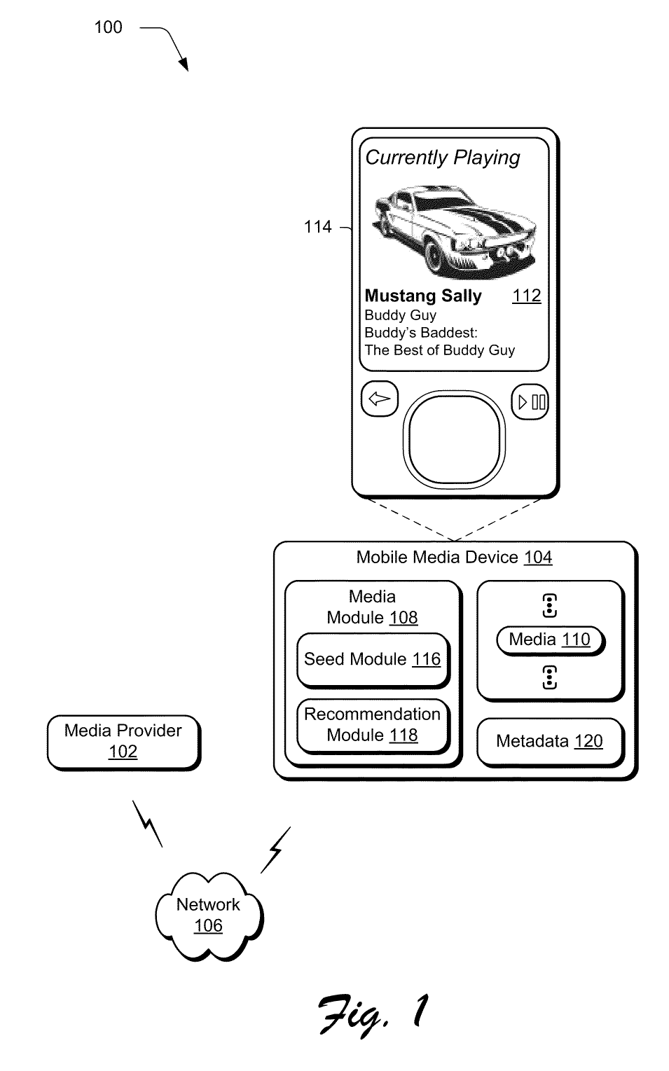

FIG. 1 is an illustration of an environment 100 in an example implementation that is operable to employ media techniques described herein. The illustrated environment 100 includes a media provider 102 that is communicatively coupled to a mobile media device 104 via a network 106. The mobile media device 104 is but one example of a computer that may be configured in a variety of ways. For example, a media module 108 of the media device 104 may include communication functionality to receive media via the network 106 and store it as media 110. The media 110 may also be obtained in a variety of other ways, such as via a local connection with another computer (e.g., wired connection with a desktop PC to “rip” music, another mobile media device via a wireless connection, and so on).

The illustrated media module 108 may also be representative of functionality of the mobile media device 104 to generate and maintain a user interface 112 for display on a display device 114 of the mobile media device 104. The user interface 112 may be configured in a variety of ways, such as to display media that is currently being played by the mobile media device 104 using functionality of the media module 108.

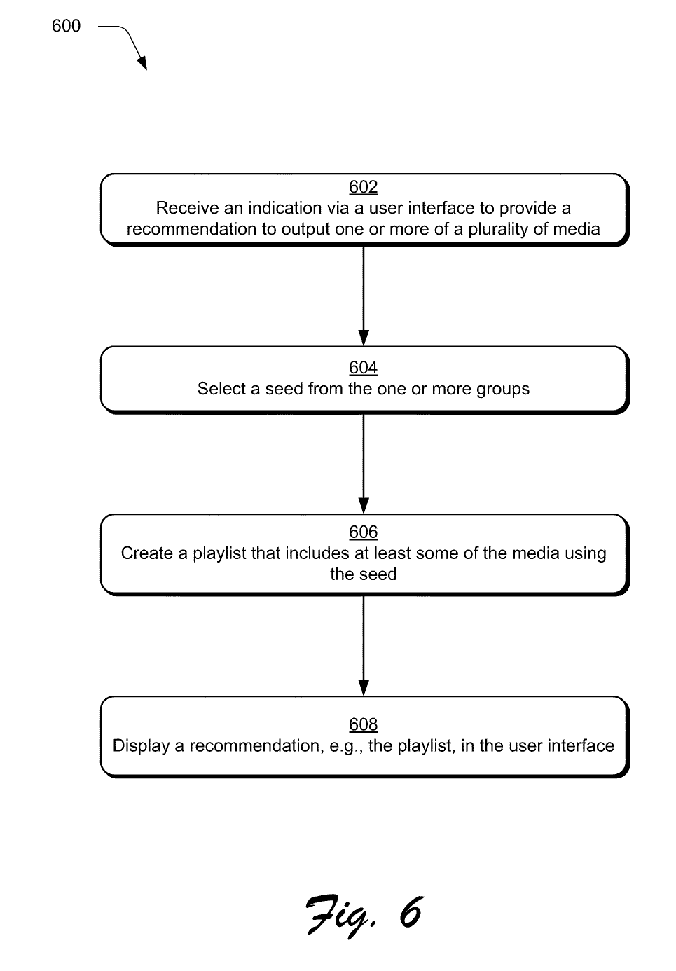

The media module 108 is also illustrated as including a seed module 116 and a recommendation module 118. The seed module 116 is representative of functionality of the media module 108 to generate a “seed” that identifies one of more the media 110, such as through examination of the media 110 itself and/or metadata 120 that is associated with the media. The seed may act as a starting point of a user experience provided by the mobile media device 104 such that a user may enjoy an efficient playback experience that leverages the media 110. The seed may be generated in a variety of ways, such as through an inverse form of one or more similarity functions. Through use of the inverse form, different listening properties of the media 110 (e.g., moods) may be captured to provide a varied user experience that may leverage an increased variety of the media 110. Further discussion of seed generation may be found in relation to FIGS. 2 and 6.

The recommendation module 118 is representative of functionality of the media module 108 to provide a framework to make recommendations involving the media 110. The framework provided by the recommendation module 118 is flexible in that the framework may employ a variety of different similarity functions to generate a playlist having one or more items of recommended media 110. For example, the recommendation module 118 may leverage the seed provided by the seed module 116 as a basis to calculate similarity of other media to generate a playlist using a plurality of similarity functions.

For instance, the recommendation module 118 may employ voting techniques such that no particular similarity function employed by the framework of the module has an undue influence (either positive or negative) as a basis for calculating similarity between the media 110. Additionally, the voting technique may be leveraged with other techniques to arrive at a final calculation of how similar the media 110 is to each other. This similarity may then be used as a basis to support a variety of other functionality, such as to generate a playlist. Although use of the seed from the seed module 116 has been described, functionality of the recommendation module 118 may also be implemented separately without the seed, e.g., to form one or more recommendations using the previously described framework. Further discussion of media recommendations may be found in relation to FIGS. 3, 4, and 7.

Generally, any of the functions described herein can be implemented using software, firmware, hardware (e.g., fixed logic circuitry), manual processing, or a combination of these implementations. The terms “module,” “functionality,” and “logic” as used herein generally represent software, firmware, hardware, or a combination thereof. In the case of a software implementation, the module, functionality, or logic represents program code that performs specified tasks when executed on a processor (e.g., CPU or CPUs). The program code can be stored in one or more computer readable memory devices. The features of the media techniques described below are platform-independent, meaning that the techniques may be implemented on a variety of commercial computing platforms having a variety of processors.

FIG. 2 depicts a system 200 in an example implementation in which the seed module 116 is shown in greater detail. The mobile media device 104 in this example is illustrated as having a processor 202 and memory 204. Processors are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions. Alternatively, the mechanisms of or for processors, and thus of or for a computer, may include, but are not limited to, quantum computing, optical computing, mechanical computing (e.g., using nanotechnology), and so forth. Additionally, although a single memory 204 is shown, a wide variety of types and combinations of memory may be employed, such as random access memory (RAM), hard disk memory, removable medium memory, and other types of computer-readable storage media.

The seed module 116 is illustrated as being executed on the processor 202 and is storable in memory 204. The seed module 116 is further illustrated as including a grouping module 206 that is representative of functionality to form one or more groups 208 of similar media 110. As illustrated, the grouping module 206 may employ a similarity function 210 (which may be representative of one or more similarity functions) to locate groups of the media 110 that have similar characteristics. Thus, each group formed using the similarity function 210 shares characteristics that are common to the group.

The seed module 116 may also employ an inverse form of a similarity function 212 (which may be the same as or different from the similarity function 210) to locate media that is dissimilar. For example, the inverse form of the similarity function 212 may be used to locate media 110 that is dissimilar in order to identify different kinds of listening properties within the media 110. In this way, groups 208 may be generated that describe similar and dissimilar media. For instance, one of the groups may reference media 110 that is “Rock” themed based on similarity (e.g., to a seed) and another one of the groups 208 may reference media 110 based on dissimilarity to the “Rock” themed group, such as ballads.

Metadata information may then be leveraged by the metadata analysis module 214 to “narrow down” a selection from the groups 208. For example, the metadata 120 may include a variety of different types of metadata 120, examples of which include media metadata 216 and user metadata 218. Media metadata 216 describes the media 110 itself, such as an artist, an album, a release date, a publisher, run time, a rating, and so on.

User metadata 218 describes a user's interaction with media, such as the media 110 of the mobile media device 104 and/or other media and thus may be considered a profile of the user. For example, the user metadata 218 may describe a play count, describe a time of day when the media 110 was played, what media 110 was played sequentially “with” particular items of the media 110 (e.g., which song preceded or followed song playback), which media 110 was included in a playlist by a user (and if so, how often), how the media 110 was obtained (e.g., download vs. “ripping”), when the media was obtained by the mobile media device 104 (e.g., when was the media 110 was caused to be downloaded over the network 106 by a user of the mobile media device 104 from the media provider 102), which of the media 110 was shared by a user of the mobile media device 104 with another user, and so on.

The metadata analysis module 214 of FIG. 2 is illustrated as being used to examine the metadata 120 associated with media 110 in the groups 208 to identify a seed 220 from each of the groups 208. The seed 220 may be used as a recommendation itself and/or to make additional recommendations through further processing by the recommendation module 118, further discussion of which may be found in relation to the following figure.

FIG. 3 depicts a system 300 in an example implementation in which the recommendation module 118 of FIG. 1 is shown in greater detail. The recommendation module 118 is illustrated as including a plurality of similarity functions 302, 304, 306. Although three similarity functions 302-306 are shown for clarity in the figure, it should be readily apparent that the recommendation module 118 is extensible and may support a variety of different numbers of similarity functions, e.g., from one to “N.”

Each of the similarity functions 302-306 is illustrated as including a respective threshold 308, 310, 312. The thresholds 308, 310, 312 (which may be the same or different, one to another) may be used in conjunction with a voting technique to determine whether the respective similarity functions 302, 304, 306 are to cast a respective vote 314, 316, 318. Although scalars are described as examples, these techniques may also employ non-scalar functions, e.g., vectors and so on.

For example, each of the similarity functions 302, 304, 306 may calculate a respective similarity value 320, 322, 324, e.g., through comparison of one item of media 110 with another. When the similarity values 320, 322, 324 indicate a relatively high likelihood of similarity based on comparison with the respective thresholds 308, 310, 312, a vote is assigned for the respective similarity function 302, 304, 306. Thus, a number of votes assigned to a media item may be used to quantify similarity of the media 110 and thus may provide a basis to form a preliminary ranking of the media 110 based on similarity by the ranking module 326.

Additional ranking techniques may also be employed by the ranking module 326. For example, the ranking module 326 may use the votes to arrive at an initial ranking of the media based on similarity. The ranking module 326 may then use the similarity values 320, 322, 324 to rank the items of media 110 that have a matching number of votes. For example, the recommendation module 118 may apply different weights to the similarity values 320, 323, 324 to arrive at a similarity total. This total may then be used to rank the media that has been assigned a matching number of votes, e.g., media that has been assigned 3 votes, 2 votes, 1 vote, or 0 votes in the illustrated example. Thus, the weights may be assigned and reassigned to affect how the media is ranked within a cluster with the votes 314-318 specifying which media 110 is included in the clusters.

The ranking module 326 may also employ a variety of other techniques with the rankings to arrive at a recommendation, examples of which are illustrated as a probability function 328 and an ordering function 330. The probability function is representative of functionality to select media to form a playlist 332. In an implementation, the probability function 328 is configured to have a higher probability of selecting from the media 110 at a top of the ranking than from a bottom of the ranking. In other words, the probability function 328 is configured to have a higher probability of selecting media 110 that is similar than dissimilar. In this way, the playlist 332 is more likely to have the media 110 arranged in different ways each time the playlist 332 is generated even though a same seed may be used each time.

The ranking module 326 is also illustrated as including an ordering function 330 that is representative of functionality to order the media 110 to form the playlist 332. A variety of different techniques may be employed. For example, the ordering function 330 may accept as an input the output of the probability function 328 and reorder sequential media 110 that has a matching artist. A variety of other examples are also contemplated, such as for reordering of media from the same albums from the same artist (e.g., when each of the media is from the same artist).

FIG. 4 illustrates a system 400 in an example implementation in which a user interface is used to configure which similarity functions are employed by the recommendation module 118 of FIG. 3. The media provider 102 in this example is illustrated as outputting a user interface 502 that includes a display of a plurality of similarity functions, 504, 506, 508, 510.

The first similarity function 504 describes a metadata function that is configured to perform metadata attribute analysis using multidimensional scaling. The second similarity function 506 describes a filtering function that is configured to use collaborative filtering to identify media that has a high co-occurrence in a community's playback usage. The third similarity function 508 references the use of digital signal processing and the fourth similarity function 510 describes a style filter 510 that describes use of detailed metadata to determine similarity, e.g., styles, textual analysis of artist information, and so on. A variety of other similarity functions may also be described in the user interface 502.

The user interface 502 also includes functionality to specify whether the referenced similarity function is to be used in making the recommendation (e.g., the “Use” column) and to assign a weight to the similarity functions (e.g., the “Weight” column) for use in ranking the media 110 as previously described.

The user interface 502 further includes an option to add/remove 512 similarity functions for use by the recommendation module 118. For example, selection of the add/remove 512 portion of the user interface 502 may provide an option to import new similarity functions and/or remove similarity functions.

Information that describes changes made may through interaction with the user interface 502 may then be communicated via the network 106 to the mobile media device 104, e.g., as an update. In this way, the recommendation module 118 may be flexible to leverage new similarity functions and/or remove similarity functions that are subsequently determined to be undesirable. Further, interaction with the user interface 502 may adjust the effect each of these functions has on the ranking, e.g., by adjusting weights, which may then be exposed for access over the network 106. A variety of other examples are also contemplated, such as through output of the user interface 502 on the mobile media player 104 itself.

### Example Procedures

The following discussion describes user interface techniques that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference will be made to the environment 100 of FIG. 1 and the systems 200, 300, 400 of FIGS. 2, 3, and 4.

FIG. 5 depicts a procedure 500 in an example implementation in which pre-processing is performed to form groups that may serve as a basis for making media recommendations. Output of a plurality of audio content by a computer is monitored and data is collected that describes the monitoring (block 502). The monitoring may be performed in a variety of ways, such as through local execution of a module on the computer and/or remotely by determining which media was communicated (e.g., streamed) to the computer.

A set of dissimilar candidates is calculated for a plurality of media using a similarity function in which the set of dissimilar candidates describe media that is dissimilar in comparison with other media included in the plurality of media (block 504). For example, the seed module 116 may examine a list of media that is often selected for playback by a user and determine groups of media 110 that are dissimilar to the user-selected media.

One or more groups are formed from the plurality of media having similar characteristics based at least in part on the set of dissimilar candidates (block 506). Continuing with the previous example, after the seed module 116 determines which media is dissimilar, the seed module 116 may then form groups of the dissimilar media. Groups may also be formed of media that is similar to the user-selected media. In this way, the groups may correspond to a wide range of styles and moods.

Data is cached that describe the one or more groups (block 508). For example, the data may be cached locally on the mobile media device 104 and/or remotely over the network, e.g., by the media provider 102. The cached data may then be used to increase efficiency of generating recommendations thereby improving an overall user experience, further discussion of which may be found in relation to the following figure.

FIG. 6 depicts a procedure 600 in an example implementation in which a seed is formed from data cached using the procedure 500 of FIG. 5. An indication is received via a user interface to provide a recommendation to output one or more of a plurality of media (block 602). For example, the indication may involve navigation to a page in a user interface that is to include the recommendations, selection of a button to generate recommendations, and so on.

A seed is selected from the one or more groups (block 604). The seed may be selected to impart a variety of different functionality. For example, selection of the seed may be based, at least in part, on current conditions for playback such as a time of day the recommended media is to be output. For instance, a user of the mobile media device 104 may select certain media 110 at different times of day to reflect a changing mood. By leveraging the user metadata 218 by the seed module 116, media 110 may be selected from the groups that correspond to this mood. Additionally, because the groups were cached in this example the selection of the media may be performed in a timely manner yet still leverage the current conditions to increase the likelihood that the selected media is desired by a user of the mobile media device 104. Although use of a time of day has been described, it should be readily apparent that a wide variety of the metadata 120 (e.g., the media metadata 216 and/or user metadata 218) may be employed without departing from the spirit and scope thereof.

A playlist is created that includes at least some of the media using the seed (block 606) and a recommendation, e.g., the playlist, is displayed in the user interface (block 608). For example, a seed may be selected from each of the groups and output in the user interface 112. Selection of the seed may cause output of the represented media as well as generation of a playlist to determine “what is played next.” The playlist may be generated in a variety of ways, an example of which is discussed in relation to the following figure.

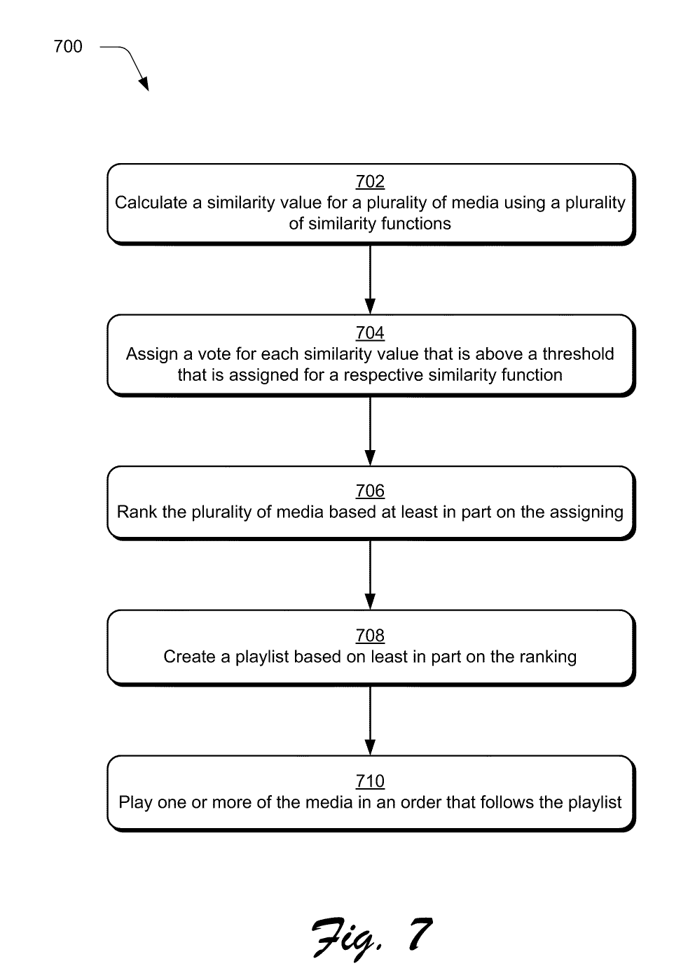

FIG. 7 depicts a procedure 700 in an example implementation in which a playlist is formed using a framework of FIGS. 3 and 4 by a seed generated using the system 200 of FIG. 2. A similarity value for a plurality of media is calculated using a plurality of similarity functions (block 702). For example, each of the similarity functions 302-306 may be used to calculate a respective similarity value 320-324.

A vote is assigned for each similarity value that is above a threshold assigned for a respective similarity function (block 704). Continuing with the previous example, if the similarity values 320-324 are “above” a respective threshold 308-312 a respective vote 314-318 is assigned. In other words, if the similarity values 320-324 indicate that the similarity of the media at least meets the threshold 308-312 for that function, the respective similarity function 302-306 “votes” that the media are similar.

The plurality of media is ranked at least in part based on the assigning (block 706) of the votes. As previously described, an initial ranking may be formed by the ranking module 326 such that media that has the greatest number of votes is ranked at the “top” of the ranking. Media that has a matching number of votes may then be ranked within that subset (i.e., media having a same number of votes) using a final value calculated from the similarity values 320-324. In an implementation, at least two of the similarity values 320-324 are given different weights to calculate the final value. Thus, each of the similarity functions may have an equal amount of “say” in calculating the initial ranking using the votes and an unequal amount of “say” in calculating ranking within subsets of the initial ranking that have a matching number of votes. In this way, recommendations may be generated to leverage a wide variety of similarity functions.

A playlist is created based on least in part on the ranking (block 708) of the plurality of media. As previously described in relation to FIG. 3, for instance, the ranking module 326 may employ the probability function and/or the ordering function 330 to finish generation of the playlist 332. One or more of the media may then be played in an order that follows the playlist (block 710), e.g., output of the media 110 by the mobile media device 104.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method implemented by a computer, the method comprising:
calculating a similarity value for a plurality of media using a plurality of similarity functions;
assigning a vote for each said similarity value that is above a threshold that is assigned for a respective said similarity function;
ranking the plurality of media based at least in part on the assigning; and
creating a playlist based at least in part on the ranking.

2. A method as described in claim 1, wherein the calculating is performed for a seed that was identified from the plurality of media.

3. A method as described in claim 2, wherein the seed is identified via an input received from a user via a user interface.

4. A method as described in claim 1, wherein the assigning is performed such that the threshold that is used for a first said similarity function is different than the threshold that is used for a second said similarity function.

5. A method as described in claim 1, wherein the ranking is performed by ordering the plurality of media based on a number of the votes assigned to corresponding said media and arranging the media having a matching number of the votes based on the similarity values calculated using the plurality of similarity functions.

6. A method as described in claim 5, wherein the arranging is performed such that a weight that is applied to the similarity value calculated by a first said similarity function is different than a weight that is applied to the similarity value that is calculated by a second said similarity function.

7. A method as described in claim 1, wherein the creating includes applying a probability function to the ranking that has a higher probability of selecting from the plurality of media at a top of the ranking than from a bottom of the ranking.

8. A method as described in claim 1, wherein the creating includes applying a function such that the playlist has a reduced likelihood of having sequential said media that shares a same artist.

9. A method as described in claim 1, wherein one or more said similarity functions involve multidimensional scaling.

10. A method as described in claim 1, wherein one or more said similarity functions involve digital signal processing.

11. A method as described in claim 1, wherein one or more said similarity functions involves collaborative filtering to identify the media that have a relatively high co-occurrence of playback in a community of mobile media devices.

12. One or more computer-readable storage media comprising instructions that are executable by a computer to output a user interface that is configured to accept a selection of one of a plurality of media and create a playlist includes at least a portion of the media by using a voting technique for a plurality of similarity functions in which votes are assigned for each similarity value that is above a threshold assigned for a respective similarity function.

13. The one or more computer-readable storage as described in claim 11, wherein the threshold that is used for a first said similarity function is different than the threshold that is used for a second said similarity function.

14. The one or more computer-readable storage as described in claim 11, wherein the instructions are further executable to create the playlist by ordering the plurality of media based on a number of the votes assigned to corresponding said media and arranging the media having a matching number of the votes based on the similarity values calculated using the plurality of similarity functions.

15. The one or more computer-readable storage as described in claim 14, wherein the arranging is performed such that a weight that is applied to the similarity value calculated by a first said similarity function is different than a weight that is applied to the similarity value that is calculated by a second said similarity function.

16. The one or more computer-readable storage as described in claim 11, wherein the creation of the playlist includes application of a probability function that has a higher probability of selecting from the plurality of media at a top of a ranking of the plurality of media than from a bottom of the ranking.

17. The one or more computer-readable storage as described in claim 11, wherein the creation of the playlist includes application of a function such that the playlist has a reduced likelihood of having sequential said media that shares a same artist.

18. One or more computer-readable storage media comprising instructions that are executable by a computer to output a user interface that:
includes a listing of a plurality of similarity functions that are configured for use in generating a playlist, each said similarity function having:
a respective assigned weight; and
a threshold for use in a voting technique in which a vote is assigned when a similarity value calculated using a respective said similarity function is above the threshold; and
is configured to receive one or more inputs to add or remove similarity function to or from the list for use in creating a playlist.

19. The one or more computer-readable storage media as described in claim 18, wherein the respective assigned weight and the threshold are displayed in the user interface.

20. The one or more computer-readable storage media as described in claim 19, wherein the respective assigned weight and the threshold are modifiable via the user interface.
